(19) United States
(12) Patent Application Publication
(10) Pub. No.: US 2026/0100758 A1
(43) Pub. Date: Apr. 9, 2026

(54) OPTICAL NETWORK DATA TRAFFIC CONTROL USING A LINK QUALITY METRIC

(71) Applicant: CISCO TECHNOLOGY, INC., San Jose, CA (US)

(72) Inventors: Randy ZHANG, Manassas, VA (US); Emerson Luis de Campos MOURA, São Paulo (BR)

(21) Appl. No.: 18/908,127

(22) Filed: Oct. 7, 2024

(51) Int. Cl. H04B 10/079; H04B 10/27

(52) U.S. Cl. CPC H04B 10/0793; H04B 10/27

(57) ABSTRACT

In one embodiment, an optical network includes a plurality of converged IP and optical routers and a plurality of optical links interconnecting the plurality of converged IP and optical routers. The optical network further includes a network controller configured to broadcast a link quality metric (LQM) to the plurality of converged IP and optical routers. The LQM defines a link quality associated with each optical link of the plurality of optical links, wherein data traffic mapping is performed by the plurality of converged IP and optical routers using the broadcast LQM.

### FIELD

The present disclosure relates to transmission of data in optical networks and more particularly to traffic control in optical networks using optical link quality.

### BACKGROUND

Computer networks can include a geographically distributed collection of nodes interconnected by communication links and segments for communicating data between end nodes, such as personal computers and workstations. The communication links can comprise optical links with data steered over different ones of the optical links using different routing protocols.

### DRAWINGS

In order that the disclosure may be well understood, there will now be described various forms thereof, given by way of example, reference being made to the accompanying drawings, in which:

FIG. 1 is a block diagram illustrating an example of a converged Internet Protocol (IP) and optical network in which data traffic is controlled in accordance with various embodiments;

FIG. 2 is a block diagram illustrating an example of converged IP and optical routers and associated optical links in accordance with various embodiments;

FIG. 3 is a block diagram illustrating an example of converged IP and optical routers and associated optical links having a link quality metric in accordance with various embodiments;

FIG. 4 is a block diagram illustrating an example process flow using a link quality metric in accordance with various embodiments; and

FIG. 5 is a block diagram of a computing device in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

As will be discussed in more detail herein, systems, methods, and computer program products are provided for processing data packets. In various embodiments, a system includes an optical network having a plurality of converged IP and optical routers and a plurality of optical links interconnecting the plurality of converged IP and optical routers. The optical network further includes a network controller configured to broadcast a link quality metric (LQM) to the plurality of converged IP and optical routers. The LQM defines a link quality associated with each optical link of the plurality of links, wherein data traffic mapping is performed by the plurality of converged IP and optical routers using the broadcast LQM.

### Example Embodiments

Different tools and mechanisms are available that may be used for optical link troubleshooting and monitoring. The use of these tools and mechanisms can result in data steering that is not reliable, and which may cause frequent, unpredictable, and unnecessary traffic switching. Accordingly, it is desirable to provide improved methods and systems for data traffic control across optical links. Furthermore, other desirable features and characteristics of the present disclosure will become apparent from the subsequent detailed description and the appended claims, taken in conjunction with the accompanying drawings and the foregoing technical field and background.

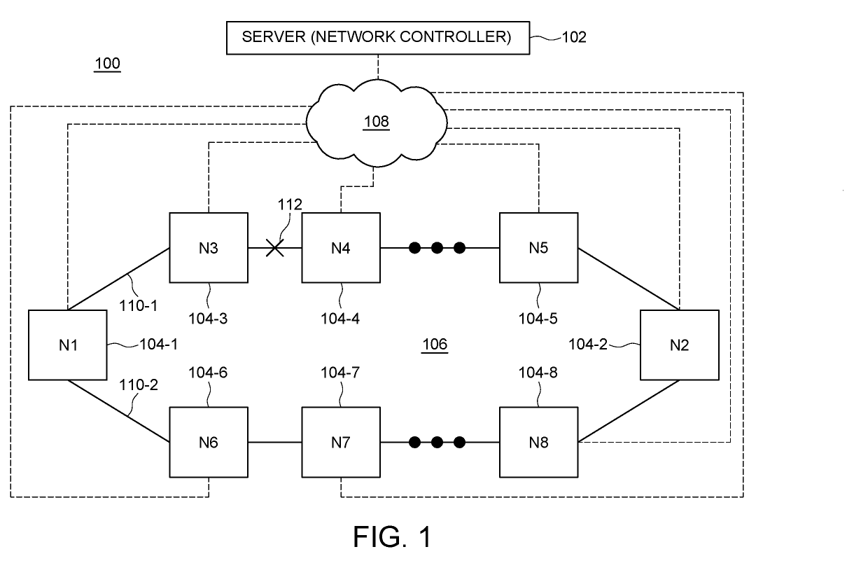

With reference to FIG. 1, a system 100 is shown that includes a routed optical network 106 in which one or more embodiments may be implemented. As described in more detail herein, a link quality metric (LQM) is used for topological planning and/or mapping of optical links within the routed optical network 106. For example, in one or more embodiments, the system 100 operates as a converged IP and optical network (e.g., a routed optical network (RON)) with integrated digital coherent optics (DCO) that provides enriched or enhanced link quality information used for topological planning and/or mapping of optical links. As a result, the link quality information can be leveraged for enhanced traffic engineering using, for example, the herein described routing metric, LQM, in routing protocols, such as flexible routing algorithms (e.g., Flex Algo Segment Routing), to deliver network slicing that operates with enhanced traffic reliability.

More particularly, the system 100 is configured in various embodiments using traffic link planning techniques for switching data traffic between different optical paths as described in more detail herein. In the illustrated example, the system 100 includes a server/network controller 102 for controlling data traffic along different optical paths in the system 100 using, for example, routers that operate according a topological schema defined using LQMs. In some embodiments, the system 100 may include one or more network controllers 102 for redundancy.

The system 100 further includes a plurality of converged IP and optical routers 104-1 to 104-8 (denoted as and also referred to herein as N1 to N8) that form the routed optical network 106. It is to be understood that additional or fewer optical nodes can be included in the optical network 106. The converged IP and optical routers 104-1 to 104-8 can be any type of routers that, in various embodiments, allow traffic routing using converged IP as described herein. For example, a RON architecture can be implemented that combines IP and optical domains. However, any type of routing architecture and controllers can be used.

The converged IP and optical routers 104-1 to 104-8 are connected to the network controller 102 through a control plane network 108, e.g., a wide area network (WAN). The converged IP and optical routers 104-1 to 104-8 may form one or more optical paths to communicate traffic in the network 106. For example, a user may desire to set up an optical path between routers N1 and N2. The user may use the network controller 102 to select the optical path.

In some embodiments, the network controller 102 is configured to identify a plurality of paths in the routed optical network 106, such as from N1 (source router) to N2 (destination router), and select one of the paths based on a topological schema defined using LQMs. Because the network data may have different priorities, quality requirements, etc. the network controller 102 may be configured to recompute or reselect paths from N1 to N2 periodically or upon a change in the type of data being communicated (e.g., data associated with critical traffic). That is, in one or more embodiments, the LQMs are used to define routing metric(s) which can be used by the communication protocol(s) when selecting data paths or links for communicating data.

In some embodiments, changes in the routed optical network 106 (e.g., changes in the data being transmitted) are communicated to the network controller 102 by the converged IP and optical routers 104-1 to 104-8 to identify alternate paths or for path computation or selection. It should be appreciated that in various embodiments, the schema is a predefined topological plan (e.g., a prebuilt topological view of every router in the routed optical network 106) that allows for mapping of the data along the optical paths as opposed to real-time data steering (e.g., proactively steering traffic in an IP over a dense wavelength division multiplexing (DWDM) network based on instantaneous error counts).

The converged IP and optical routers 104-1 to 104-8 in some embodiments provide data traffic updates to the network controller 102 that correspond to the detected quality of the network to allow for changing the path resources that remaps traffic (e.g., routes traffic with better quality) as opposed to rerouting traffic during data transmission. The network controller 102 can use the updates to determine the status of the converged IP and optical routers 104-1 to 104-8 that corresponds to the quality of the links between the converged IP and optical routers 104-1 to 104-8. As illustrated in FIG. 1, the network controller determines at least two optical paths 110-1 and 110-2 between N1 and N2 and the corresponding predefined LQMs along each of the optical paths 110-1 and 110-2. The path 110-1 includes the converged IP and optical router 104-1 (source router N1), the converged IP and optical router 104-1 (destination router N2), and one or more intermediate converged IP and optical routers 104-3, 104-4, and 104-5 (intermediate routers N3, N4, and N5). The path 110-2 includes the converged IP and optical router 104-1 (source router N1), the converged IP and optical router 104-2 (destination router N2), and one or more intermediate converged IP and optical router 104-6, 104-7, and 104-8 (intermediates routers N6, N7, and N8). Although three intermediate converged IP and optical routers are illustrated for one optical path in FIG. 1, it is to be understood that more or fewer intermediate nodes may be included in the optical paths.

After the network controller 102 determines the plurality of optical paths between N1 and N2, the network controller 102 may be configured to select one of the paths from the plurality of paths, based on a path-selection policy and previously determined LQMs for the paths (e.g., LQMs for associated optical links). It should be noted that the mapping or remapping of traffic (e.g., selection of different optical paths or links) can be automatically determined, semi-automatically determined, or manually determined (e.g., by a user). In one or more embodiments, the available path that satisfies data transmission constraints provided by the path policy is selected as the transmission path (e.g., lowest LQM indicating the highest quality is selected for data transmissions requiring higher quality optical links). For explanatory purposes, the network controller 102 selects the optical path 110-1 as the transmission path for some types of data and the optical path 110-2 as the transmission path for other types of data. For example, the optical paths are selected based on a priority or an importance level of the data to be transmitted.

In one or more embodiments, after the paths 110-1 and 110-2 are selected, the network controller 102 is configured to perform signaling of one or more of the paths 110-1, 110-2 in a control plane, and activating the one or more paths 110-1, 110-2 in a data-plane so as to set up the one or more paths 110-1, 110-2 for transmitting traffic from the N1 (source router) to the N2 (destination router). In some embodiments, when activating the one or more paths 110-1, 110-2 in the data-plane, the network controller 102 determines and forwards initial data-plane parameters for optical components of the nodes in the one or more paths 110-1, 110-2 to the nodes in the one or more paths 110-1, 110-2, including the converged IP and optical routers 104, to set up the optical components for receiving optical signals. It should be noted that one or more switches or other optical device(s) 112 may be provided within one or more of the paths 110.

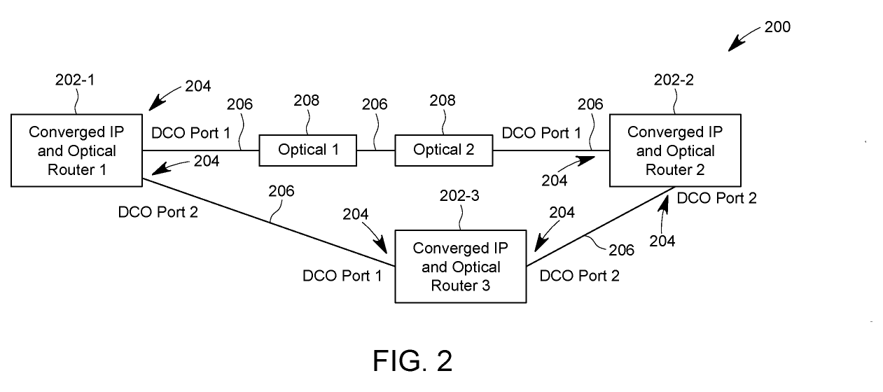

In some embodiments, the one or more paths 110-1, 110-2 may experience a change in the data traffic, such as the type, amount, etc. of the data to be transmitted. The network controller 102 is able to provide improved (e.g., more reliable) data transmission using data planning and/or mapping based at least in part on LQMs. For example, FIG. 2 illustrates a converged IP and optical network 200 that maps data traffic according to various embodiments. In this example, converged IP and optical routers 202 are each configured as a router with one or more integrated DCO interfaces. That is, each of the converged IP and optical routers 202 includes one or more DCO ports 204, illustrated as DCO Port 1 and DCO Port 2, that allows for communicative connection of the converged IP and optical routers 202. It should be appreciated that while three converged IP and optical routers 202 are shown, communicative connection to one or more additional converged IP and optical routers 202 (or other routers) is contemplated.

Connection between the converged IP and optical routers 202 is provided using one or more DCO links 206 (e.g., using one or more optical devices 208 or directly over a pair of dark fibers). FIG. 2 shows a simplified view where the converged IP and optical routers 202 connect over the optical devices 208 or over dark fibers. In particular, converged IP and optical router 202-1 connects to converged IP and optical router 202-2 with one of the DOC ports 204 (e.g., DCO Port 1) over the two optical devices 208 (illustrated as Optical 1 and Optical 2 devices). The optical devices 208 may be optical wavelength switches or other types of optical devices. Converged IP and optical router 202-1 connects to converged IP and optical router 202-3 over a pair of dark fibers using one of the DCO ports 204 (e.g., DCO Port 2). Similarly, converged IP and optical router 202-2 connects to converged IP and optical router 202-3 over a pair of dark fibers using one of the DCO ports 204 (e.g., DCO Port 2). Thus, optical connection is provided between the converged IP and optical routers 202 using the DCO links 206 that define different optical paths (which may be provided using different optical communication means).

In operation in one or more embodiments, each of the converged IP and optical routers 202 periodically collects optical link quality data for each DCO interface, such as corresponding to each of the DCO ports 204. The interface LQM in some embodiments is computed based on system defaults or user-configurations, but other suitable computational methods may be used. The LQM may be mapped to a segment routing identifier and advertised through an interior gateway protocol (IGP) to all other supporting routers in the domain (e.g., other converged IP and optical routers 202). As such, the LQM for each DCO interface is then available to all routers, for example, participating in the flexible routing algorithm (e.g., Flex Algo) that supports the link quality, based on the LQM, and is able to create topologies for link quality based on traffic engineering needs. That is, in one or more embodiments, a topological view of every router, for example every converged IP and optical router 202 in the converged IP and optical network 200, is created and allows for mapping and remapping of optical data traffic as described in more detail herein.

In various embodiments, the LQM is a quantity (e.g., numerical quality value) numerically inversely related to the link quality and may be user configurable in terms of selecting, for example, a link quality parameter and setting mapping thresholds (e.g., one or more threshold values), as well as other operating characteristics or parameters. In one or more examples, a higher metric corresponds to a lower link quality. The knowledge of link quality allows operators and/or system controllers to introduce a traffic reliability concept by mapping traffic that needs more reliability to links that have higher link quality (for lower LQM) or excluding links that do not satisfy a minimal link quality metric through constraint-based traffic engineering. That is, topological planning to map and remap traffic is performed using the LQM. It should be noted that the LQM can be determined or calculated based on different factors or measured properties, for example, a quality margin (Q Margin) and/or a quality factor (Q Factor), or other quality determinations, which is made available to the converged IP and optical routers 202 as described in more detail herein.

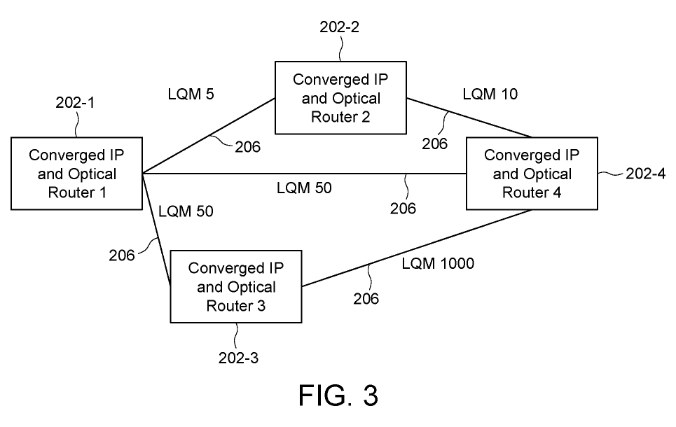

FIG. 3 shows a simplified example that illustrates traffic control utilizing LQM values, which are shown for each of the DCO links 206. As can be seen in this example, showing four IP and optical routers 202-1, 202-2, 202-3, 202-4, the highest link quality path (with the lowest LQM value – sum of the values along the path) is through the IP and optical router 202-2, which may use to transmit critical data traffic or other data traffic of high importance. It should be noted that in various embodiments, each link, for example each of the DCO links 206 has a defined LQM that is fixed as described in more detail herein. That is, the LQM value for each DCO link 206 once determined is fixed and defines part of a traffic control schema. However, if changes occur to the quality of the actual DCO link 206 (e.g., physical damage to a link) then the LQM value for that DCO link 206 may be adjusted or changed.

In one or more embodiments, network operators (or network controllers) may also decide to exclude the link between the IP and optical router 202-3 and the IP and optical router 202-4 for traffic that requires higher reliability. As such, manual or automatic data traffic link selection can be more reliably mapped using the LQMs. Using a data traffic schema or plan based on LQMs allows for taking traffic control actions based on, for example, quality definitions associated with the data traffic being transmitted. For example, actual link quality may change, which results in a change to the types of data traffic communication over the various links.

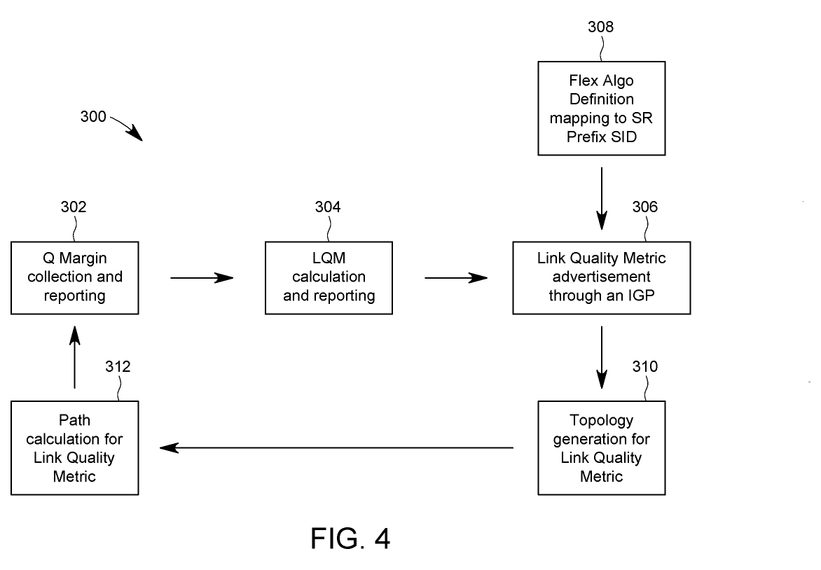

FIG. 4 shows an embodiment of a high-level workflow 300 using the LQM. In some examples, the Q Margin is selected as the optical link quality to determine the corresponding LQM and Flex Algo Segment Routing that is used for metric mapping and path selection. In particular, Q Margin data is continually collected by each DCO port 204 and made available to the host operating system by reporting the Q Margin data at 302. It should be noted that to more accurately reflect the real link quality, operators or controllers (e.g., control systems) may collect data at different defined intervals, such as once per hour with aggregated reporting once per every twenty-four hours by selecting the minimal, maximal, average, or median values within the twenty-four hour period. However, data collection, such as Q Margin data collection can be performed using any time interval(s) or time frame(s) as desired or needed.

The reported Q Margin is then converted into the LQM at 304. That is, LQM calculation and reporting is performed based on the acquired Q Margin data. It should be appreciated that the Q Margin can be converted or translated into LQM values using any suitable means to result in values usable by the herein described systems, and for advertisement through an IGP at 306. That is, the calculated LQM values can be communicated (e.g. broadcast) to the IP and optical routers 202 for use in data traffic mapping as described in more detail herein. It should be noted that in various embodiments, in order to reduce or minimize unnecessary fluctuations of Layer 3 traffic forwarding, a dampening range is used. In some examples, LQM data is updated only when a reported twenty-four hour Q Margin crosses the range.

The following are examples of mapping Q Margins to LQMs:

(1) LQM 1000 (Very low link quality): Quality Margin 0.01-0.50;

(2) LQM 50 (Low link quality): Quality Margin 0.51-1.00;

(3) LQM 10 (High link quality): Quality Margin 1.01 – 1.5; and

(4) LQM 5 (Very high link quality): Quality Margin >1.5

It should be appreciated that the above values are merely for example and different mappings and values may be provided based on different factors, different operating requirements, etc. As described in more detail herein, a Prefix SID (segment identifier) may be used as a label for a prefix in segment routing (SR) at 308.

With the LQMs advertised, in some examples, topology generation for the LQM is performed at 310. For example, as described herein, a topological view is generated that can be used by each of the IP and optical routers 202 after advertisement of the LQMs to perform path calculation at 312. As further described herein, path calculation using the LQMs can be based on the type of data traffic being communicated over the optical links.

Thus, in various examples, instead of performing routing that uses metrics based on link bandwidth, latency, or traffic engineering (TE), all of which may not reliably reflect the underlying optical link quality, a link metric type, namely link quality, as defined by the LQM is used. It should be noted that this metric type is ignored by routers that do not support the LQM, which is in accordance with the Flex Algo implementation, where routers do not expect to support all the algorithms. For uniform support, standardization may be required, such as through IETF for vendor interoperability.

In operation and with reference also again to FIG. 1, one or more embodiments can implement LQM that may be used in traffic engineering for link inclusion or exclusion based on link quality. For example, a policy may stipulate that all links for the policy must have a maximum LQM, so that any links that have greater LQM are automatically excluded for that class of data traffic. Operators and/or control systems (e.g., the network controller 102) may also use priority to further affect path selection.

Thus, the network controller 102 is configured in various examples to facilitate mapping and/or remapping to one or more of the paths 110. As such, remapped paths 110 in some examples replace originally mapped paths 110 based on the topological definitions determined from the LQMs.

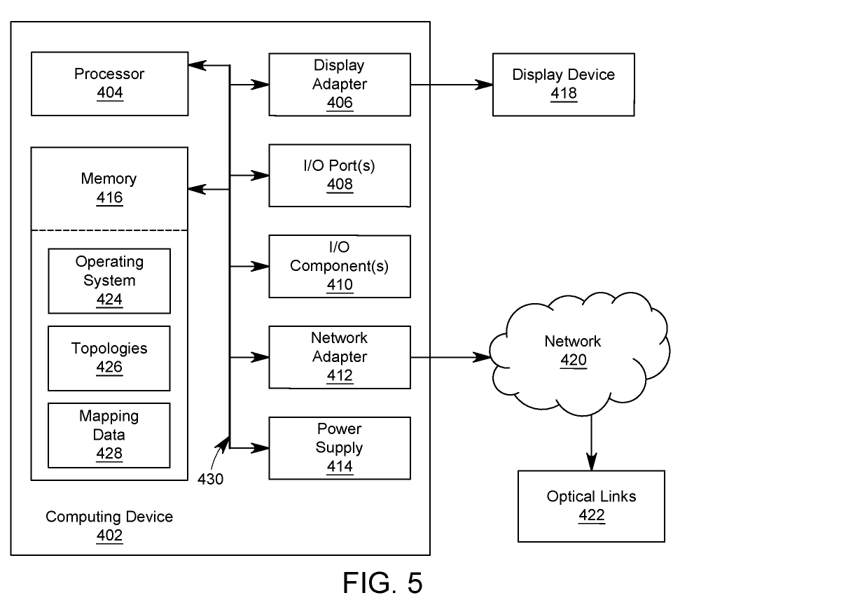

FIG. 5 illustrates an operating environment that facilitates the performance of the systems and methods described herein. More specifically, the systems and methods described herein, including the components, processors, servers, controllers (e.g., the network controller 102). etc. can be implemented on a computing device 402. For example, the computing device 402 can be a personal computer, a desktop, a laptop, a tablet, a hand-held computer, a server, a workstation, a mainframe, a wearable computer, a supercomputer, or a combination thereof. However, it is understood that the aforementioned examples of what the computing device 402 may be is non-exhaustive and that the computing device 402 can be any related device. The computing device 402 generally includes a processor 404, a display adapter 406, one or more input/output port(s) 408, one or more input/output component(s) 410, a network adapter 412, a power supply 414, and a memory 416. However, it is understood that the computing device 402 can include any additional components therein and is not required to include any of the listed components (e.g., the processor 404, the display adapter 406, the one or more input/output port(s) 408, the one or more input/output component(s) 410, the network adapter 412, the power supply 414, and the memory 416).

The processor 404 is configured to provide instructions and/or processing power to the computing device 402 so that the computing device 402 can process one or more tasks including the implementation of a software program. It is also understood that the computing device 402 may include any number or processors 404 therein. The display adapter 406 can be a graphics card or a video board that provides the computing device 402 with a capability to display content on a display device 418. For example, the display device 418 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device 418 may be is non-exhaustive and that the display device 418 can be any related device.

The input/output port(s) 408 provides a number of sockets for one or more cables to connect to the computing device 402. It is understood that there may be any number of input/output port(s) 408 on the computing device 402. For example, the input/output port(s) 408 provides a means for the computing device 402 to receive signals and/or data from an external device connected to the computing device 402 via the one or more cables. As another example, the input/output port(s) 408 provides a means for the computing device 402 to send signals and/or data from an external device connected to the computing device 402 via the one or more cables. The input/output component(s) 410 can include one or more components that support the input/output port(s) 408 such as, but not limited to, a switch, a push button, a pressure mat, a float switch, a keypad, a radio receive, or a combination thereof.

A network adapter 412 can be a network interface controller that is configured to provide a means for communicating over a network 420 using one or more optical links 422 as described in more detail herein. The power supply 414 is configured to convert alternating high voltage current (e.g., AC) into direct current (e.g., DC) to provide regulated power to the other components (e.g., the processor 404, the display adapter 406, the one or more input/output port(s) 408, the one or more input/output component(s) 410, the network adapter 412, and the memory 416) of the computing device 402.

Additionally, the memory 416 can be a mass storage device and/or a system memory such as a hard disk drive, a memory card, a solid-state drive, random access memory (RAM), or a combination thereof. The memory 416 is configured to provide a holding place for instructions and data associated with the operation of the computing device 402. The memory 416 can generally include an operating system 424, a one or more topologies 426, and mapping data 428. For example, the operating system 424 is configured to manage one or more topologies 426 and/or process any of the data and/or instructions associated therewith using mapping data 428 based on LQMs as described in more detail herein.

Furthermore, a system bus 430 is also included within the computing device 402 that is configured to couple each of the various components (e.g., the processor 404, the display adapter 406, the one or more input/output port(s) 408, the one or more input/output component(s) 410, the network adapter 412, the power supply 414, and the memory 416) of the computing device 402. While the operating environment illustrated within FIG. 5 depicts a particular configuration associated with at least the computing device 402 and the network 420, it is understood that the operating environment may be configured in any way.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs and/or cause one or more processors to perform one or more particular functions. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An optical network, comprising:
a plurality of converged IP and optical routers;
a plurality of optical links interconnecting the plurality of converged IP and optical routers; and
a network controller configured to broadcast a link quality metric (LQM) to the plurality of converged IP and optical routers, wherein the LQM defines a link quality associated with each optical link of the plurality of optical links, wherein data traffic mapping is performed by the plurality of converged IP and optical routers using the broadcast LQM.

2. The optical network of claim 1, wherein the plurality of converged IP and optical routers are configured to select one or more optical links of the plurality of optical links using the broadcast LQM and based on a type of data traffic to be transmitted.

3. The optical network of claim 2, wherein the one or more optical links comprise optical links with a highest link quality path determined by the LQM.

4. The optical network of claim 1, wherein the plurality of converged IP and optical routers are configured to exclude one or more optical links of the plurality of optical links using the broadcast LQM and based on a type of data traffic to be transmitted.

5. The optical network of claim 4, wherein the one or more optical links comprise optical links with a link quality path determined by the LQM that is below a threshold value for the type of data traffic to be transmitted.

6. The optical network of claim 1, wherein the LQM associated with each optical link of the plurality of optical links is used to create one or more optical network topologies for controlling network traffic.

7. The optical network of claim 1, wherein the plurality of converged IP and optical routers each have digital coherent optics (DCO) ports associated with an LQM value.

8. The optical network of claim 1, wherein the LQM is calculated from Q Margin data.

9. A method for network traffic control, the method comprising:
calculating, by a processor, a link quality metric (LQM) for each optical link of a plurality of optical links interconnecting a plurality of converged IP and optical routers;
broadcasting the LQM to the plurality of converged IP and optical routers to cause the plurality of converged IP and optical routers to perform data traffic mapping using the broadcast LQM; and
transmitting data traffic via the plurality of optical links based using the data traffic mapping.

10. The method of claim 9, wherein the plurality of converged IP and optical routers are configured to select one or more optical links of the plurality of optical links using the broadcast LQM and based on a type of data traffic to be transmitted.

11. The method of claim 10, wherein the one or more optical links comprise optical links with a highest link quality path determined by the LQM.

12. The method of claim 9, wherein the plurality of converged IP and optical routers are configured to exclude one or more optical links of the plurality of optical links using the broadcast LQM and based on a type of data traffic to be transmitted.

13. The method of claim 12, wherein the one or more optical links comprise optical links with a link quality path determined by the LQM that is below a threshold value for the type of data traffic to be transmitted.

14. The method of claim 9, further comprising creating one or more optical network topologies for controlling network traffic using the LQM associated with each optical link of the plurality of optical links.

15. The method of claim 9 wherein the plurality of converged IP and optical routers each have digital coherent optics (DCO) ports associated with an LQM value.

16. The method of claim 9, wherein the LQM is calculated from Q Margin data.

17. A system for controlling data traffic, comprising:
a plurality of processors; and
a non-transitory computer-readable storage medium storing instructions which, when executed by the plurality of processors, cause the plurality of processors to:
calculate a link quality metric (LQM) for each optical link of a plurality of optical links interconnecting a plurality of converged IP and optical routers;
broadcast the LQM to the plurality of converged IP and optical routers to cause the plurality of converged IP and optical routers to perform data traffic mapping using the broadcast LQM; and
transmit data traffic via the plurality of optical links based on the LQM.

18. The system of claim 17, wherein the plurality of converged IP and optical routers are configured to select one or more optical links of the plurality of optical links using the broadcast LQM and based on a type of data traffic to be transmitted or exclude one or more optical links of the plurality of optical links using the broadcast LQM and based on a type of data traffic to be transmitted.

19. The system of claim 18, wherein the selected one or more optical links comprise optical links with a highest link quality path determined by the LQM and the excluded one or more optical links comprise optical links with a link quality path determined by the LQM that is below a threshold value for the type of data traffic to be transmitted.

20. The system of claim 17, wherein the non-transitory computer-readable storage medium storing instructions which, when executed by the plurality of processors, further cause the plurality of processors to create one or more optical network topologies for controlling network traffic using the LQM associated with each optical link of the plurality of optical links.
